(19) United States
(12) Patent Application Publication
(10) Pub. No.: US 2024/0227438 A1
(43) Pub. Date: Jul. 11, 2024

(54) Firm-Grip Rim

(71) Applicant: Jalco Industry Co., Ltd., Huatan Township (TW)

(72) Inventor: Han-Tsung Chen, Huatan Township (TW)

(21) Appl. No.: 18/325,271

(22) Filed: May 30, 2023

(30) Foreign Application Priority Data
Jan. 10, 2023 (TW) 112200288

(51) Int. Cl. B60B 21/02

(52) U.S. Cl. CPC B60B 21/021; B60B 21/025; B60B 2200/47; B60B 2900/325; B60B 2900/523

(57) ABSTRACT

A firm-grip rim includes two walls, an internal ring, an external ring and two flanges. The walls extend in an annular manner. The internal ring is formed between the walls. The external ring extends around the internal ring and includes two lateral portions connected to the walls respectively. Each of the flanges extends outward from a corresponding one of the walls in a radial direction so that there is a corner between it and a corresponding one of the lateral portions of the external ring. Each of the flanges includes an internal side formed with a grip device.

### BACKGROUND OF INVENTION

### 1. Field of Invention

The present invention relates to a rim of a wheel and, more particularly, to a firm-grip rim.

### 2. Related Prior Art

A tire is arranged around and griped by a rim of a wheel of a bicycle for example. Two beads of the tire are expected to be in firm contact with two flanges of the rim when the tire is inflated. Thus, the tire is given proper rigidity in a radial direction and in a lateral direction. However, the tire is inevitably biased relative to the rim in the radial direction due to change in a road surface, tilting of the wheel, movement of the center of weight of a rider or inadequate pressure in the tire. Thus, a gap might occur between one of the beads and one of the flanges. The gap might be too large to keep the tire around the rim.

The present invention is therefore intended to obviate or at least alleviate the problems encountered in the prior art.

### SUMMARY OF INVENTION

It is the primary objective of the present invention to provide a firm-grip rim.

To achieve the foregoing objective, the firm-grip rim includes two walls, an internal ring, an external ring and two flanges. The walls extend in an annular manner. The internal ring is formed between the walls. The external ring extends around the internal ring and includes two lateral portions connected to the walls respectively. Each of the flanges extends outward from a corresponding one of the walls in a radial direction so that there is a corner between it and a corresponding one of the lateral portions of the external ring. Each of the flanges includes an internal side formed with a grip device.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a cut-away view of a rim of a wheel according to the preferred embodiment of the present invention;

FIG. 2 is a cross-sectional view of the rim shown in FIG. 1;

FIG. 3 is an enlarged partial view of the rim shown in FIG. 1;

FIG. 4 is a cross-sectional view of a tire and the rim shown in FIG. 1;

FIG. 5 is an enlarged partial view of wheel and the rim shown in FIG. 4;

FIG. 6 is a cut-away partial view of the wheel and the rim shown in FIG. 4.

### DETAILED DESCRIPTION OF PREFERRED EMBODIMENT

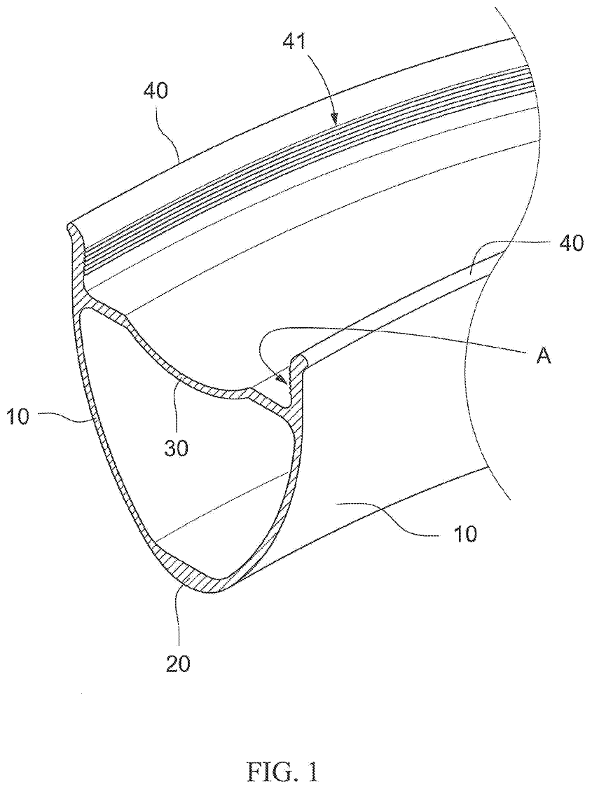

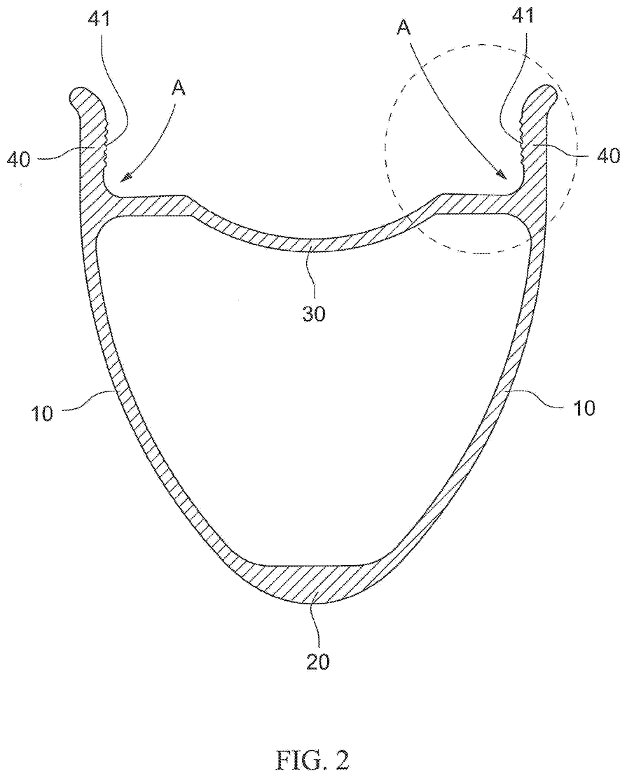

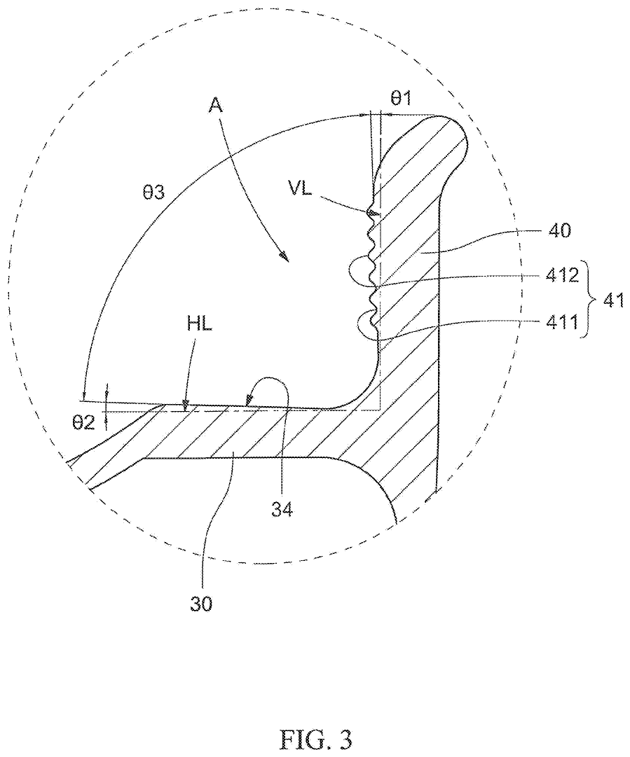

Referring to FIGS. 1 through 3, a firm-grip rim includes two walls 10, an internal ring 20, and external ring 30 and two flanges 40 according to the preferred embodiment of the present invention.

Each of the walls 10 is an annular portion of the firm-grip rim. The walls 10 extend away from each other as they extend outward in a radial direction.

The internal ring 20 is located between and connected to the walls 10.

The external ring 30 is located between and connected to the walls 10. A diameter of the external ring 30 is larger than a diameter of the internal ring 20. The external ring 30 extends around the internal ring 20.

Each of the flanges 40 extends outward from a corresponding one of the walls 10. Each lateral portion 34 of the external ring 30 is connected to a corresponding one of the flanges 40 and a corresponding one of the walls 10. There is a corner A between each of the lateral portions 34 of the external ring 30 and the corresponding one of the flanges 40.

Each of the flanges 40 includes a grip device 41 on an internal side. The grip device 41 includes multiple grooves 411 separating multiple ridges 412 from one another.

The flanges 40 extend toward each other as they extend outward in a radial direction. The thickness of the flanges 40 is constant. Hence, there is an angle θ1 between the internal side of each of the flanges 40 and a vertical line or plane VL. The angle θ1 is about 2 to 6 degrees and, more preferably, 1 to 3 degrees. There is an angle θ2 between each of the lateral portions 34 of the external ring 30 and a horizontal line or plane HL. The angle θ2 is about 2 to 6 degrees and, more preferably, 1 to 3 degrees. Accordingly, an angle θ3 of the corner A is about 84 to 88 degrees.

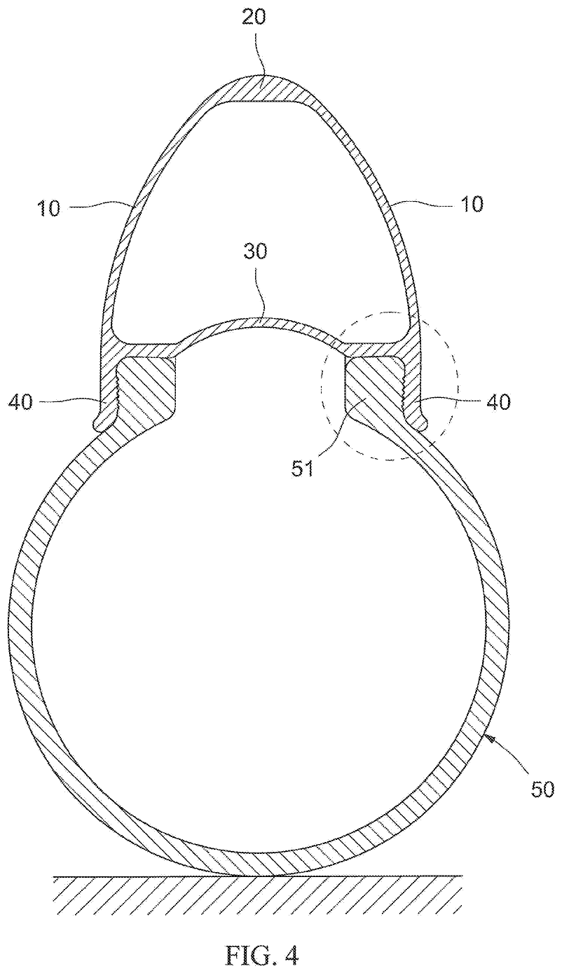

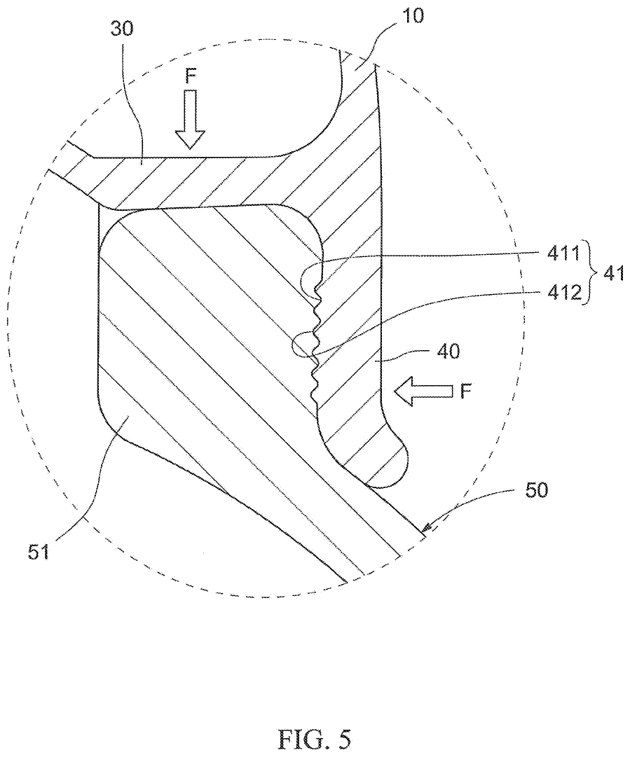

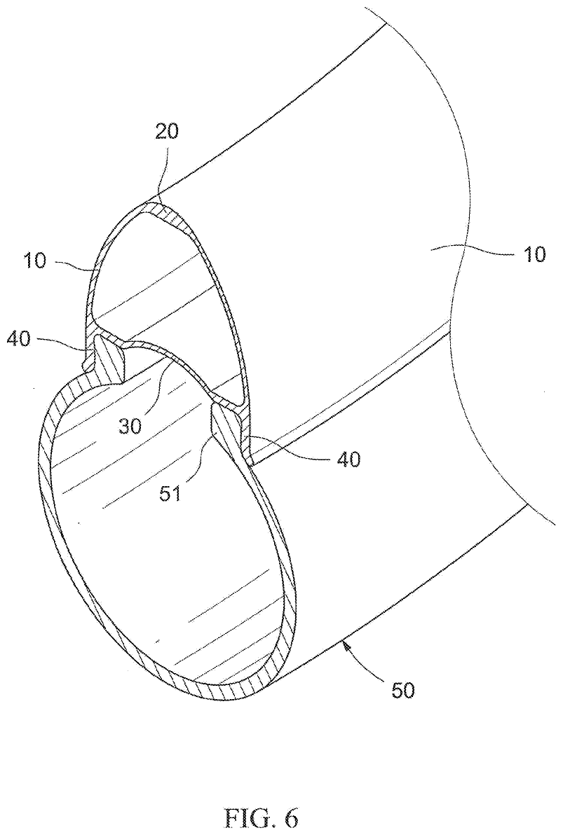

Referring to FIGS. 4 through 6 as well as FIGS. 1 through 3, a tire 50 includes two beads 51 respectively inserted in the corners A of the firm-grip rim. Proper elasticity of the tire 50 allows the beads 51 to be in firm contact with the external ring 30. External sides of the beads 51 are in firm contact with the grip devices 41 of the flanges 40. As the angle θ3 of the corner A is smaller than 90 degrees, each of the flanges 40 and the corresponding one of the of lateral portions 34 of the external ring 30 together form a clamp for clamping the corresponding one of the beads 51 of the tire 50 as indicated by arrow heads F shown in FIG. 5.

During a normal ride, rigidity of the tire 50 is retained due to the contact, the grip and the clamp mentioned above. In case of change in a road surface, tilting of the rim, movement of the center of weight of a rider or variation of the pneumatic pressure of inadequate pressure in the tire, the tire 50 inevitably suffer elastic deformation. In such a case, the gripping of the beads 51 of the tire 50 by the grip devices 41 and the clamping of the beads 51 of the tire 50 by the corners A of which the angle θ3 are smaller than 90 degrees. Thus, the engagement of the beads 51 of the tire 50 with the combination of the external ring 30 with the flanges 40 is retained.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A firm-grip rim comprising:
two walls (10) extending in an annular manner;
an internal ring (20) formed between the walls (10);
an external ring (30) extending around the internal ring (20) and comprising two lateral portions (34) connected to the walls (10) respectively; and
two flanges (40) each of which extends outward from a corresponding one of the walls (10) in a radial direction so that there is a corner (A) between it and a corresponding one of the lateral portions (34) of the external ring (30), wherein each of the flanges (40) comprises an internal side formed with a grip device (41).

2. The firm-grip rim according to claim 1, wherein the grip device (41) comprises grooves (411) and ridges (412) separated from one another by the grooves (411).

3. The firm-grip rim according to claim 1, wherein each of the flanges (40) is tilted from a vertical line (VL) toward the external ring (30) for an angle of about 2 to 6 degrees.

4. The firm-grip rim according to claim 1, wherein each of the lateral portions (34) of the external ring (30) is biased from a horizontal line (HL) toward the corresponding one of the flanges (40) for an angle of about 2 to 6 degrees.

5. The firm-grip rim according to claim 1, wherein there is an angle of about 84 to 88 degrees between each of the lateral portions (34) of the external ring (30) and the corresponding one of the flanges (41).
